(19) United States
(12) Patent Application Publication
(10) Pub. No.: US 2010/0057419 A1
(43) Pub. Date: Mar. 4, 2010

(54) Fold-wise classification of proteins

(75) Inventors: Hampapathalu Adimurthy Nagarajaram, Hyderabad (IN); Tabrez Anwar Shamim Mohammad, Hyderabad (IN)

Correspondence Address: DARBY & DARBY P.C., P.O. BOX 770, Church Street Station, New York, NY, 10008-0770, US

(73) Assignee: Laboratory of Computational Biology, Center for DNA Fingerprinting and Diagnostics, Hyderabad (IN)

(21) Appl. No.: 12/257,915

(22) Filed: Oct. 24, 2008

(30) Foreign Application Priority Data
Aug. 29, 2008 (IN) 2122/CHE/2008

(51) Int. Cl. G06G 7/58

(52) U.S. Cl. 703/11

(57) ABSTRACT

This disclosure relates to methods, apparatus, computer programs and computing devices related systems for predicting the fold pattern of a protein of interest having an unknown fold pattern, using SVM classification methods and systems.

### CROSS REFERENCE TO RELATED APPLICATIONS

The present application claims the benefit of Indian Patent Application Serial No. 2122/CHE/2008, filed Aug. 29, 2008, the contents of which are hereby incorporated by reference.

### BACKGROUND

Protein fold recognition is an important step in discovering the 3D structure of proteins, especially when traditional sequence comparison methods fail to yield convincing structural homologies. Although many methods have been developed for protein fold recognition, their fold prediction accuracies remain low. This can be attributed to insufficient exploitation of fold discriminatory features inherent in proteins.

The gap between the number of proteins with and without 3-dimensional (3D) structural information has been increasing alarmingly owing to the successful completion of many genome-sequencing projects. Since the 3D structure of proteins is important for understanding how proteins function, and as not all proteins are amenable to experimental structure determination, computational prediction of 3D protein structures has, therefore, become a helpful alternative to experimental determination of 3D structures.

Among the computational prediction approaches, fold recognition/threading methods have taken central stage. In instances where detection of homology becomes difficult even when using the best sequence comparison methods such as PSI-BLAST (Altschul et al., 1997), structure-based fold recognition approaches are often employed. Many methods have been developed for assigning folds to protein sequences. These methods can be broadly classified in three categories: (a) sequence-structure homology recognition methods such as FUGUE (Shi et al., 2001) and 3DPSSM (Kelley et al., 2000), (b) threading methods such as THREADER (Jones et al., 1992), and (c) taxonomic methods such as PFP-Pred (Shen and Chou, 2006).

Sequence-structure homology recognition methods align target sequence onto known structural templates and calculate their sequence-structure compatibilities using either profile based scoring functions (Kelley et al., 2000) or environment specific substitution tables (Shi et al., 2001). The scores obtained for different structural templates are then ranked and the template, which gives rise to the best score, is assumed to be the fold of the target sequence. Unfortunately, these methods, although widely used, have not been able to achieve accuracies >30% at the fold level (Cheng and Baldi, 2006), which could be attributed to the fact that these methods use substitutions to detect folds that are evolutionally related. Threading methods, which use pseudo-energy based functions (Jones et al., 1992) to calculate sequence-structure compatibilities, also yield poor accuracies perhaps due to the difficulty of formulating reliable and general scoring functions.

Taxonomic methods for protein fold recognition, such as the one developed by Ding and Dubchak (2001) and PFP-Pred (Shen and Chou, 2006) that give prediction accuracies of about 60%, assume that the number of protein folds in the universe is limited and therefore, the protein fold recognition can be viewed as a fold classification problem where a query protein can be classified into one of the known folds. In this classification scheme one needs to identify fold-specific features that can discriminate between different folds. Available taxonomic methods for protein fold recognition use amino acid composition, pseudo amino acid composition, and selected structural and physico-chemical propensities of amino acids as fold discriminatory features. Ding and Dubchak (2001) used amino acid composition and features extracted from structural and physico-chemical propensities of amino acids to train the discriminatory classifier. The Ensemble classifier approach for protein fold recognition developed by Shen and Chou (2006) used different orders of pseudo amino acid composition and structural and physicochemical propensities of amino acids as features.

### BRIEF DESCRIPTION OF THE DRAWINGS

FIG. 1 shows an operational flow representing illustrative embodiments of operations related to predicting the fold pattern of a protein having an unknown fold pattern.

FIG. 2 shows optional embodiments of the operational flow of FIG. 1.

FIG. 3 shows optional embodiments of the operational flow of FIG. 1.

FIG. 4 shows optional embodiments of the operational flow of FIG. 1.

FIG. 5 shows optional embodiments of the operational flow of FIG. 1.

FIG. 6 shows a partial view of an illustrative embodiment of a computer program product that includes a computer program for executing a computer process on a computing device.

FIG. 7 shows an illustrative embodiment of a system in which embodiments may be implemented.

FIG. 8 A-C shows the fold-wise sensitivity and specificity for the classifier feature 10 using three multi-class methods.

FIG. 9 A-C shows the fold-wise sensitivity and specificity for the classifier feature 10 using three multi-class methods.

FIG. 10 shows the prediction accuracy (Q) for protein fold recognition reported by different fold recognition methods.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here.

This disclosure is drawn, inter alia, to methods, apparatus, computer programs and computing devices related systems for predicting the fold pattern of a protein of interest having an unknown fold pattern, using SVM classification methods and systems. In particular, this disclosure provides mechanisms to more accurately predict the fold pattern of a protein of interest having an unknown fold pattern so that its 3D structure can be ascertained, leading to information regarding the protein's ultimate structure, and/or function.

The term “about” or “approximately” means within an acceptable range for the particular value as determined by one of ordinary skill in the art, which will depend in part on how the value is measured or determined, e.g., the limitations of the measurement system. For example, “about” can mean a range of up to 20%, up to 10%, up to 5%, and/or up to 1% of a given value. Alternatively, particularly with respect to biological systems or processes, the term can mean within an order of magnitude, within 5-fold, and within 2-fold, of a value. Unless otherwise stated, the term ‘about’ means within an acceptable error range for the particular value.

The terms “percent (%) sequence similarity,” “percent (%) sequence identity,” and the like, refer to the degree of identity or correspondence between different nucleotide sequences of nucleic acid molecules or amino acid sequences of proteins that may or may not share a common evolutionary origin. Sequence identity can be determined using any of a number of publicly available sequence comparison algorithms, such as BLAST, FASTA, DNA Strider, GCG (Genetics Computer Group, Program Manual for the GCG Package, Version 7, Madison, Wis.), etc.

To determine the percent identity between two amino acid sequences or two nucleic acid molecules, the sequences are aligned for optimal comparison purposes. The percent identity between the two sequences is a function of the number of identical positions shared by the sequences (i.e., percent identity=number of identical positions/total number of positions (e.g., overlapping positions)×100). The percent identity between two sequences can be determined using techniques similar to those described below, with or without allowing gaps. In calculating percent sequence identity, typically exact matches are counted.

A “polynucleotide” or “nucleotide sequence” is a series of nucleotide bases (also called “nucleotides”) in a nucleic acid, such as DNA and RNA, and means any chain of two or more nucleotides. A nucleotide sequence typically carries genetic information, including the information used by cellular machinery to make proteins and enzymes. These terms include double or single stranded genomic and cDNA, RNA, any synthetic and genetically manipulated polynucleotide, and both sense and anti-sense polynucleotide (although only sense stands are being represented herein). This includes single- and double-stranded molecules, i.e., DNA-DNA, DNA-RNA and RNA-RNA hybrids, as well as “protein nucleic acids” (PNA) formed by conjugating bases to an amino acid backbone. This also includes nucleic acids containing modified bases, for example thio-uracil, thio-guanine and fluoro-uracil.

The term “gene,” also called a “structural gene” means a DNA sequence that codes for or corresponds to a particular sequence of amino acids which comprise all or part of one or more proteins or enzymes, and may or may not include regulatory DNA sequences, such as promoter sequences, which determine for example the conditions under which the gene is expressed. Some genes, which are not structural genes, may be transcribed from DNA to RNA, but are not translated into an amino acid sequence. Other genes may function as regulators of structural genes or as regulators of DNA transcription.

As used herein, the term “amino acid or amino acids” means any molecule that contains both amino and carboxylic acid functional groups, including, but not limited to, alpha amino acids in which the amino and carboxylate functionalities are attached to the same carbon, the so-called α-carbon. Amino acids may include natural amino acids, unnatural amino acids, and arbitrary amino acids.

As used herein, the term “amino acid residue or amino acid residues” means the remainder of an amino acid incorporated into a peptide/protein.

As used herein, the term “natural amino acid” includes, but is not limited to, one or more of the amino acids encoded by the genetic code. The genetic codes of all known organisms encode the same 20 amino acid building blocks with the rare exception of selenocysteine and pyrolysine (Methods (2005) 36:227-238). In some embodiments, natural amino acids may also include, but not be limited to, any one or more of the amino acids found in nature. In some embodiments, these natural amino acids may include, but not be limited to, amino acids from one or more of plants, microorganisms, prokaryotes, eukaryotes, protozoa or bacteria. In some embodiments, natural amino acids may include, but are not limited to, amino acids from one or more of mammals, yeast, Escherichia coli, or humans.

As used herein, the term “peptide, peptides, protein, proteins” means polypeptide molecules, and or a segment or fragment thereof, formed from linking various amino acids in a defined order. The link between one amino acid residue and the next forms a bond, including but not limited to an amide or peptide bond, or any other bond that can be used to join amino acids. The peptides/proteins may include any polypeptides of two or more amino acid residues. The peptides/proteins may include any polypeptides including, but not limited to, ribosomal peptides and non-ribosomal peptides. The peptides/proteins may include natural and unnatural amino acid residues. The number of amino acid residues optionally includes, but is not limited to, at least 5, 10, 25, 50, 100, 200, 500, 1,000, 2,000 or 5,000 amino acid residues. The number of amino acid residues optionally includes, but is not limited to, 2 to 5,000, 2 to 2,000, 2 to 1,000, 2 to 500, 2 to 250, 2 to 100, 2 to 50, 2 to 25, 2 to 10, 5 to 5,000, 5 to 2,000, 5 to 1,000, 5 to 500, 5 to 250, 5 to 100, 5 to 50, 10 to 5,000, 10 to 2,000, 10 to 1,000, 10 to 500, 10 to 250, 10 to 100, or 10 to 50.

As used herein, the term “plurality” refers to a number greater than 1. For example, a plurality of proteins refers to two or more proteins, or segments or fragments thereof. A plurality of proteins can originate from a collection of two or more individual proteins, or from a collection of a set of proteins, such as a library.

As used herein, “protein fold,” and “fold pattern,” are used interchangeably and refer to the physical shape that is taken by a polypeptide chain when it folds into its characteristic and functional three-dimensional structure. Each protein begins as a polypeptide translated from a sequence of mRNA as a linear chain of amino acids. Portrayal of the protein as a linear chain of amino acids does not fully reflect the three-dimensional structure of the protein. Each amino acid in the linear chain has intrinsic chemical features, including, but not limited to, hydrophobicity, hydrophilicity, or electrical charge, for example. The interaction of these features among the amino acids of the protein, as well as with their surroundings in the cell, for example, contribute to produce a well-defined, three dimensional shape (i.e., structure), the folded protein known as the native state.

As used herein, the term “orphan fold” refers to the protein folds for which only one three-dimensional structure has been determined till date. The proteins belonging to these folds are referred to as “orphan proteins”.

As used herein the terms “support vector machines” and “SVM” refer to sets of related supervised learning methods used for classification and regression. SVMs belong to a family of generalized linear and non-linear classifiers. A special property of SVMs is that they simultaneously minimize the empirical classification error and maximize the geometric margin; hence they are also known as maximum margin classifiers. Viewing input data as two sets of vectors in an n-dimensional space, an SVM will construct a separating hyperplane in that space, one which maximizes the “margin” between the two data sets. To calculate the margin, two parallel hyperplanes are constructed, one on each side of the separating one, which are “pushed up against” the two data sets. Intuitively, a good separation is achieved by the hyperplane that has the largest distance to the neighboring datapoints of both classes. The goal is that, the larger the margin or distance between these parallel hyperplanes, the better the generalization error of the classifier will be.

As used herein, the term “amino acid composition” pertaining to a protein refers to a fixed length vector in 20-dimensional space. The composition of an amino acid i in a protein is calculated using the formula:

$${f}_{i} = \frac{{N}_{i}}{L}$$

where fᵢ=frequency of amino acid i; Nᵢ=number of amino acid i found in that protein; L=total number of amino acid residues found in that protein, and i=1 to 20.

Amino acid pair composition, or an nth order amino acid pair, encapsulates the interaction between the ith and (i+n)th (n>0) amino acid residues and gives the local order information as well as the composition of amino acids in a protein. Amino acid pair composition is a 400 (20×20) dimensional representation of protein information. The nth order of amino acid pair composition in a protein is calculated using the formula:

$${f ( {D}^{i , i + n} )}_{j} = \frac{{N ( {D}^{i , i + n} )}_{j}}{L - n}$$

where f (D^{i,j+n})ⱼ is the frequency of an nth order amino acid pair j; N(D^{i,j+n})ⱼ is the number of nth order amino acid pair j; n is the order of amino acid pair; j=1 to 400 and L is length of protein chain.

As used herein, “secondary structural state (H, E, C) frequencies of amino acids” refers to the frequencies of amino acids found in helices (H), β-strands (E), and coils (C) in a given protein and are collectively represented as a 60 (20×3) dimensional vector. The frequencies can be calculated using the formula:

$${f}_{i}^{k} = \frac{{N}_{i}^{k}}{L}$$

where k=(H, E, C); fᵢ^{k} is the frequency of amino acid i occurring in the secondary structural state k, and Nᵢ^{k} is the number of amino acid i found in the secondary structural state k.

As used herein, the term “secondary structural state frequencies of amino acid pairs” pertaining to a protein refers to what collectively represents a 1200 (400×3) dimensional vector. Secondary structural state frequency of an n-order amino acid pair can be calculated using the formula:

$${f ( {D}_{k}^{i , i + n} )}_{j} = \frac{{N ( {D}_{k}^{i , i + n} )}_{j}}{L - n}$$

where k=(H, E, C); f (Dₖ^{i,j+n})ⱼ is the frequency of an nth order amino acid pair j in secondary structural state k, N(Dₖ^{i,j+n})ⱼ is the number of an nth order amino acid pair j found in secondary structural state k, and L is length of protein sequence.

As used herein, the term “secondary structural state frequencies of 1-gap dipeptides” refers to secondary structural state frequencies of a second order amino acid pair, i.e., where n is 2 is the formula immediately above.

As used herein, the term “solvent accessibility state (B, E) frequencies of amino acids” pertaining to a protein refers to a 40-dimensional representation of protein structural information and is calculated as follows:

$${f}_{i}^{k} = \frac{{N}_{i}^{k}}{L}$$

where k=(B, E); fᵢ^{k} is the frequency of amino acid i in solvent accessibility state k, Nᵢ^{k} is the number of amino acid i in solvent accessibility state k, and L is length of protein sequence.

As used herein, the term “solvent accessibility state frequencies of amino acid pairs” pertaining to a protein refers to a 1200-dimensional representation of protein structural information. The solvent accessibility state frequency of an nth order amino acid pair is calculated using the formula:

$${f ( {D}_{k}^{i , i + n} )}_{j} = \frac{{N ( {D}_{k}^{i , i + n} )}_{j}}{L - n}$$

where k=(B, E, I); f(Dₖ^{i,j+n})ⱼ and N(Dₖ^{i,j+n})ⱼ are the frequency and number of the nth order amino acid pair j found in solvent accessibility state k, and L-n is the total number of nth order amino acid pairs.

As used herein, the term “solvent accessibility state frequencies of 1-gap dipeptides” refers to solvent accessibility state frequencies of a second order amino acid pair, i.e., where n is 2 is the formula immediately above.

One embodiment is a method for predicting the fold pattern of a protein of interest having an unknown fold pattern, implemented on a programmed computer, by (a) performing Support Vector Machine (SVM) analysis on a plurality of proteins each having its own known fold pattern, wherein the known fold pattern is recognized by the programmable computer based on amino acid residue sequence and amino acid residue pair structural features, thereby resulting in a correlation between the two or more structural or sequence features of the plurality of proteins having known fold patterns and the protein structural or sequence features; (b) inputting the amino acid sequence of the protein of interest having an unknown fold pattern into the programmed computer; (c) instructing the programmed computer to compare two or more structural or sequence features of the protein of interest having an unknown fold pattern to the correlation generated from the plurality of proteins having known fold patterns; and (d) predicting the fold pattern of the protein of interest having an unknown fold pattern which is predicted by the programmed computer by comparing i) the two or more structural or sequence features of the protein of interest having an unknown fold pattern, to ii) the correlation generated from the plurality of proteins having known fold patterns.

Another embodiment is a program storage device accessible by a programmable computer embodying a program of instructions executable by the programmable computer to perform method steps for protein fold recognition by receiving the amino acid sequence of a plurality proteins having a known fold pattern, establishing a correlation between the known fold patterns and two or more structural or sequence features of the plurality of proteins having a known fold pattern, wherein the two or more structural or sequence features are characterized from amino acid residue and amino acid residue pair information of the proteins having a known fold pattern, receiving the amino acid sequence of a protein of interest having an unknown fold pattern, comparing two or more structural or sequence features of the protein of interest having an unknown fold pattern with the correlation determined from the two or more proteins having a known fold pattern, and predicting the fold pattern of the protein of interest having an unknown fold pattern based on the comparison.

In the disclosed embodiments, protein sequence features include: (1) amino acid composition; (2) first order amino acid pair (dipeptide) composition; (3) second order amino acid pair (1-gap dipeptide) composition. In disclosed embodiments, protein structural features include: (4) secondary structural state frequencies of amino acids; (5) secondary structural state frequencies of dipeptides; (6) secondary structural state frequencies of 1-gap dipeptides; (7) solvent accessibility state frequencies of amino acids; (8) solvent accessibility state frequencies of dipeptides; and (9) solvent accessibility state frequencies of 1-gap dipeptides.

Yet another embodiment is a system for predicting the fold pattern of a protein of interest having an unknown fold pattern by training the system to correlate one or more fold patterns of a plurality of proteins having a known fold pattern to two or more structural or sequence features of the known proteins. The system then predicts the fold pattern of a protein of interest having an unknown fold pattern by receiving the amino acid sequence of the protein of interest having an unknown fold pattern so that the system can associate the protein amino acid sequence of the protein of interest having an unknown fold pattern with two or more structural or sequence features of the protein of interest having an unknown fold pattern. The system then uses two or more structural or sequence features of the protein of interest having an unknown fold pattern, compares them to the correlation, and thereby predicts the fold pattern of the protein of interest having an unknown fold pattern.

Yet another embodiment is a system for predicting the fold pattern of a protein of interest belonging to orphan fold pattern by training the system to correlate one or more known fold patterns of a plurality of proteins having known fold patterns to two or more structural or sequence features of the known proteins. The system then predicts the fold pattern of an orphan protein of interest having an unknown fold pattern by receiving the amino acid sequence of the orphan protein of interest having an unknown fold pattern so that the system can associate the protein amino acid sequence of the orphan protein of interest having an unknown fold pattern with two or more structural or sequence features of the orphan protein of interest having an unknown fold pattern. The system then uses two or more structural or sequence features of the orphan protein of interest having an unknown fold pattern, compares them to the correlation, and thereby predicts the fold pattern of the orphan protein of interest having an unknown fold pattern.

SVM classifiers can be used to help predict the fold pattern or proteins of interest having an unknown fold pattern based on classifying certain variables, or features, of the proteins, and comparing those features to the same features in proteins having a known fold pattern. First, a SVM system is “trained” to correlate a known protein fold pattern to two or more structural or sequence features in a plurality of proteins each having its own known fold pattern. Then, after SVM training, the sequence of a protein of interest (which characterizes a protein's structural and sequence features) having an unknown fold pattern can be input into the SVM-trained system. The system will then predict the fold pattern of a protein of interest having an unknown fold pattern by comparing two or more structural or sequence features of the protein of interest (which are recognized by the system based on the protein's amino acid sequence), to the correlations obtained during SVM training using a plurality of proteins having a known fold pattern (e.g., the training protein set).

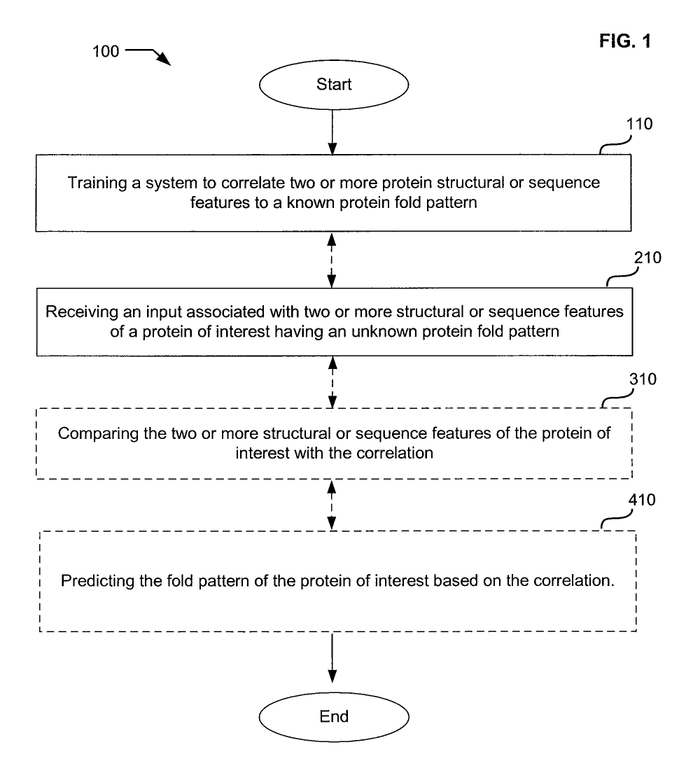

FIG. 1 shows an operational flow 100 representing illustrative embodiments of operations related to determining the protein fold pattern of a protein of interest having an unknown fold pattern. In FIG. 1, and in the following figures that include various illustrative embodiments of operational flows, discussion and explanation may be provided with respect to apparatus and methods described herein, and/or with respect to other examples and contexts. The operational flows may also be executed in a variety of other contexts and environments, and or in modified versions of those described herein. In addition, although some of the operational flows are presented in sequence, the various operations may be performed in various repetitions, concurrently, and/or in other orders than those that are illustrated.

After a start operation, the operational flow 100 moves to an optional training operation 110 where a system is trained to correlate two or more structural or sequence features to a known fold pattern in a plurality of known proteins having one or more known fold patterns. For example, a plurality of proteins with known fold patterns can be used as a dataset to train a system to correlate the fold patterns with two or more structural or sequence features of the protein. Proteins include segments and fragments of proteins.

After an optional training operation, the operational flow 100 moves to a receiving operation 210 where receiving a first input is associated with two or more structural or sequence features of a protein of interest having an unknown fold pattern. For example, a first input may include data representative of the amino acid sequence of a protein of interest having an unknown fold pattern, said amino acid sequence being associated with the protein of interest's structural and sequence features. The input may occur manually, as by input through a data entry device such as a keyboard, or by receiving data associated with two or more structural or sequence features from a database such as a data pool on the internet.

Comparison operation 310 operates to compare the two or more structural or sequence features of the protein of interest having an unknown fold pattern with the correlation of optional operation 110. For example, two structural features of a protein of interesting having an unknown fold pattern are compared to a dataset of correlations of the same two structural features to protein fold patterns in proteins having a known fold patter.

A predictive operation 410 operates to predict the fold pattern of a protein of interest having an unknown fold pattern based on comparing the correlation of two or more structural or sequence features of a protein of interest having an unknown fold pattern, having an unknown fold pattern, to a correlation of two or more structural or sequence features of a plurality of proteins having known fold patterns.

Operations 110 to 410 may be performed with respect to a digital representation (e.g. digital data) of, for example, data representative of protein folds, structural and sequence features of proteins, amino acid sequence of a protein, and/or correlations between structural and sequence features of a protein and protein folds. The logic may accept a digital or analog (for conversion into digital) representation of an input and/or provide a digitally-encoded representation of a graphical illustration, where the input may be implemented and/or accessed locally or remotely.

Operations 110 to 410 may also be performed related to either a local or a remote storage of the digital data, or to another type of transmission of the digital data. In addition to inputting, accessing querying, recalling, calculating, determining or otherwise obtaining the digital data, operations may be performed related to storing, assigning, associating, displaying or otherwise archiving the digital data to a memory, including for example, sending and/or receiving a transmission of the digital data from a remote memory. Accordingly, any such operations may involve elements including at least an operator (e.g. human or computer) directing the operation, a transmitting computer, and/or receiving computer, and should be understood to occur in the United States as long as at least one of these elements resides or occurs in the United States.

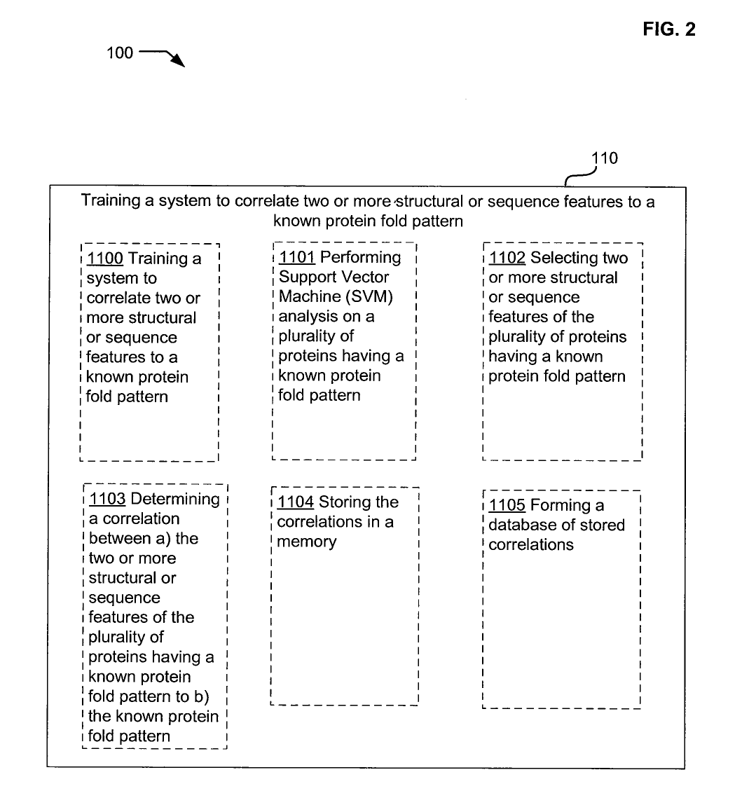

FIG. 2 illustrates embodiments of the operational flow 100 of FIG. 1. FIG. 2 shows illustrative embodiments of the training operation 110, training a system to correlate two or more structural or sequence features to a known protein fold pattern, including.

At the optional operation 1100, a system is trained to correlate structural and sequence features of a protein to a known fold pattern. At the operation 1101, the system performs support vector machine analysis on a plurality of proteins having one or more known fold patterns. The plurality of proteins having known fold patterns allow the system to recognize correlations between the known fold patterns and structural and sequence features of the proteins with the folds.

At operation 1102, the system selects two or more structural or sequence features of the plurality of proteins having a known fold pattern. For example, the two or more structural or sequence features of the plurality of proteins having a known protein fold pattern selected may be secondary structural state frequencies of amino acids and solvent accessibility state frequencies of amino acids. In another embodiment, the two or more structural or sequence features of the plurality of proteins having a known protein fold pattern may be secondary structural state frequencies of dipeptides and solvent accessibility state frequencies of dipeptides. In another embodiment, the two or more structural or sequence features of the plurality of proteins having a known protein fold pattern may be secondary structural state frequencies of 1-gap dipeptides and solvent accessibility state frequencies of 1-gap dipeptides. In another embodiment, the two or more structural or sequence features of the plurality of proteins having a known protein fold pattern may be secondary structural state frequencies of amino acids, secondary structural state frequencies of dipeptides, and secondary structural state frequencies of 1-gap dipeptides. In another embodiment, the two or more structural or sequence features of the plurality of proteins having a known protein fold pattern may be solvent accessibility state frequencies of amino acids, solvent accessibility state frequencies of dipeptides, and solvent accessibility state frequencies of 1-gap dipeptides. In yet another embodiment, the two or more structural or sequence features of the plurality of proteins having a known protein fold pattern may be secondary structural state frequencies of amino acids, secondary structural state frequencies of dipeptides, solvent accessibility state frequencies of amino acids, and solvent accessibility state frequencies of dipeptides. In yet another embodiment, the two or more structural or sequence features of the plurality of proteins having a known protein fold pattern may be secondary structural state frequencies of amino acids, secondary structural state frequencies of 1-gap dipeptides, solvent accessibility state frequencies of amino acids, and solvent accessibility state frequencies of 1-gap dipeptides. In another embodiment, the two or more structural or sequence features of the plurality of proteins having a known protein fold pattern may be secondary structural state frequencies of dipeptides, secondary structural state frequencies of 1-gap dipeptides, solvent accessibility state frequencies of dipeptides, and solvent accessibility state frequencies of 1-gap dipeptides. In another embodiment, the two or more structural or sequence features of the plurality of proteins having a known protein fold pattern may be secondary structural state frequencies of amino acids, secondary structural state frequencies of dipeptides, secondary structural state frequencies of 1-gap dipeptides, solvent accessibility state frequencies of amino acids, solvent accessibility state frequencies of dipeptides, and solvent accessibility state frequencies of 1-gap dipeptides.

At operation 1103, the system determines a correlation between (a) the two or more structural or sequence features of the plurality of proteins having one or more known fold patterns, and (b) the known fold pattern(s).

At optional operation 1104, the correlations may be stored in a memory. For example, the system may store the correlation between any a fold and associated structural and sequence features in a hard disk, or in a data pool such as an internet dataset. It is envisioned that the stored correlations may be recalled by a user or a system at any time. Optionally, one or more correlations between structural and sequence features of proteins and their known fold pattern can be used to create a database of the correlations. The optional database may be temporally updated and is not limited by size or format. A correlations database may also, for example, be accessed by the system to improve the optional training operation or enhance the predictive operation 410.

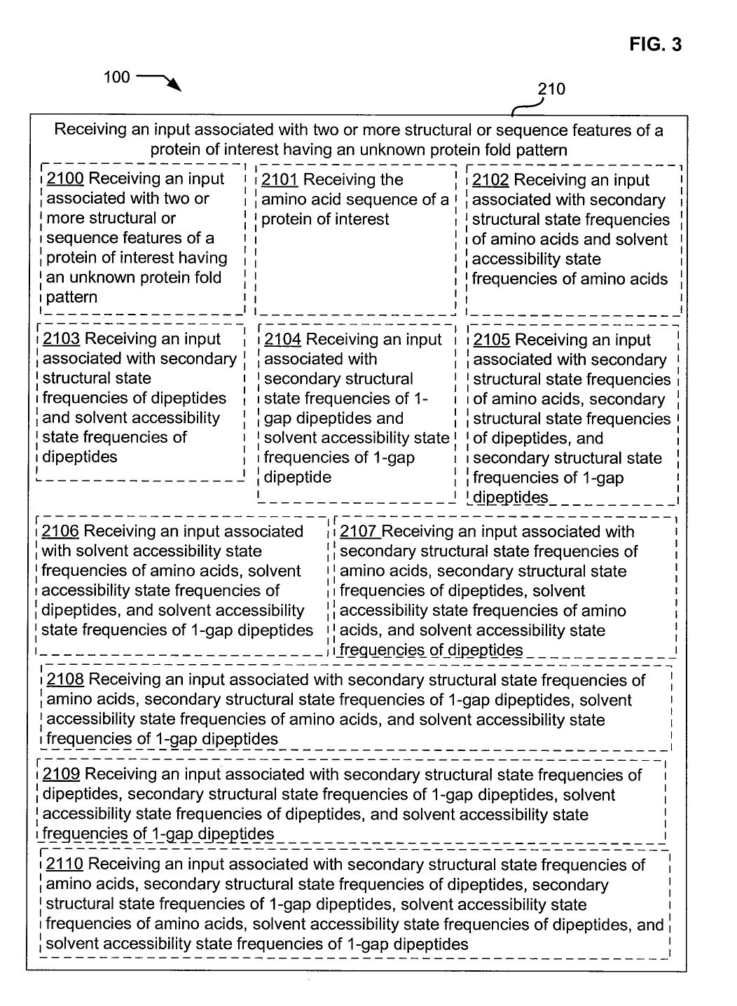

FIG. 3 illustrates embodiments of the operational flow 100 of FIG. 1. FIG. 3 shows illustrative embodiments of the receiving operation 210, receiving an input associated with two or more structural or sequence features of a protein of interest having an unknown fold pattern.

At the optional operation 1100, a system receives an input associated with two or more structural or sequence features of a protein of interest having an unknown fold pattern. At optional operation 1101, the system receives the amino acid sequence of a protein of interest having an unknown fold pattern.

There are a variety of structural or sequence features of a protein (or a segment or fragment thereof) that can be received by the system. At optional operation 2102, one embodiment of the system receives secondary structural state frequencies of amino acids and solvent accessibility state frequencies of amino acids. At optional operation 2103 one embodiment receives an input associated with secondary structural state frequencies of dipeptides and solvent accessibility state frequencies of dipeptides. At optional operation 2104, one embodiment receives an input associated with secondary structural state frequencies of 1-gap dipeptides and solvent accessibility state frequencies of 1-gap dipeptides. At optional operation 2105, one embodiment receives an input associated with secondary structural state frequencies of amino acids, secondary structural state frequencies of dipeptides and secondary structural state frequencies of 1-gap dipeptides. At optional operation 2106, one embodiment receives an input associated with solvent accessibility state frequencies of amino acids, solvent accessibility state frequencies of dipeptides, and solvent accessibility state frequencies of 1-gap dipeptides. At optional operation 2107, one embodiment receives an input associated with secondary structural state frequencies of amino acids, secondary structural state frequencies of dipeptides, solvent accessibility state frequencies of amino acids, and solvent accessibility state frequencies of dipeptides. At optional operation 2108, one embodiment receives an input associated with secondary structural state frequencies of amino acids, secondary structural state frequencies of 1-gap dipeptides, solvent accessibility state frequencies of amino acids, and solvent accessibility state frequencies of 1-gap dipeptides. At optional operation 2109, one embodiment receives an input associated with secondary structural state frequencies of dipeptides, secondary structural state frequencies of 1-gap dipeptides, solvent accessibility state frequencies of dipeptides, and solvent accessibility state frequencies of 1-gap dipeptides. At optional operation 2110, one embodiment receives an input associated with secondary structural state frequencies of amino acids, secondary structural state frequencies of dipeptides, secondary structural state frequencies of 1-gap dipeptides, solvent accessibility state frequencies of amino acids, solvent accessibility state frequencies of dipeptides, and solvent accessibility state frequencies of 1-gap dipeptides.

In embodiments described herein, an input that is “associated with” two or more structural or sequence features of a protein having a known fold pattern is not limited to a protein's amino acid sequence. It is envisioned that other inputs can be associated with the structural or sequence features of proteins. For example, physical or chemical characteristics of proteins that are associated with the structural or sequence features of a protein could be inputs.

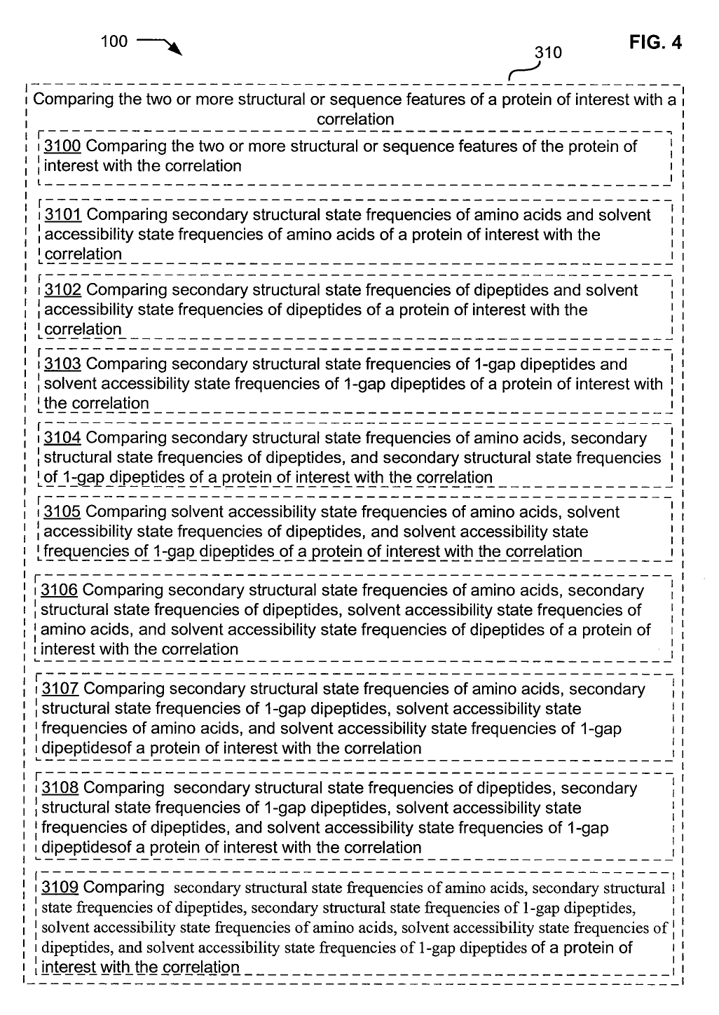

FIG. 4 illustrates embodiments of the operational flow 100 of FIG. 1. FIG. 4 shows illustrative embodiments of the receiving operation 310, comparing two or more structural or sequence features of a protein of interest having an unknown fold pattern with one or more correlations between two or more structural or sequence features of a plurality of proteins having a known fold pattern, and the known fold pattern.

At the optional operation 3100, a system compares two or more structural or sequence features of a protein of interest having an unknown fold pattern with a correlation. At optional operation 3101, one embodiment of the system compares secondary structural state frequencies of amino acids and solvent accessibility state frequencies of amino acids, of a protein of interest having an unknown fold pattern, with a correlation. At optional operation 3102, one embodiment compares secondary structural state frequencies of dipeptides and solvent accessibility state frequencies of dipeptides, of a protein of interest having an unknown fold pattern, with a correlation. At optional operation 3103, one embodiment compares secondary structural state frequencies of 1-gap dipeptides and solvent accessibility state frequencies of 1-gap dipeptides, of a protein of interest having an unknown fold pattern, with a correlation. At optional operation 3104, one embodiment compares the secondary structural state frequencies of amino acids, secondary structural state frequencies of dipeptides and secondary structural state frequencies of 1-gap dipeptides, of a protein of interest having an unknown fold pattern, with a correlation. At optional operation 3105, one embodiment compares solvent accessibility state frequencies of amino acids, solvent accessibility state frequencies of dipeptides, and solvent accessibility state frequencies of 1-gap dipeptides, of a protein of interest having an unknown fold pattern, with a correlation. At optional operation 3106, one embodiment compares secondary structural state frequencies of amino acids, secondary structural state frequencies of dipeptides, solvent accessibility state frequencies of amino acids, and solvent accessibility state frequencies of dipeptides, of a protein of interest having an unknown fold pattern, with a correlation. At optional operation 3107, one embodiment compares secondary structural state frequencies of amino acids, secondary structural state frequencies of 1-gap dipeptides, solvent accessibility state frequencies of amino acids, and solvent accessibility state frequencies of 1-gap dipeptides, of a protein of interest having an unknown fold pattern, with a correlation. At optional operation 3108, one embodiment compares secondary structural state frequencies of dipeptides, secondary structural state frequencies of 1-gap dipeptides, solvent accessibility state frequencies of dipeptides, and solvent accessibility state frequencies of 1-gap dipeptides, of a protein of interest having an unknown fold pattern, with a correlation. At optional operation 3109, one embodiment compares secondary structural state frequencies of amino acids, secondary structural state frequencies of dipeptides, secondary structural state frequencies of 1-gap dipeptides, solvent accessibility state frequencies of amino acids, solvent accessibility state frequencies of dipeptides, and solvent accessibility state frequencies of 1-gap dipeptides, of proteins of interest having an unknown fold pattern, with a correlation.

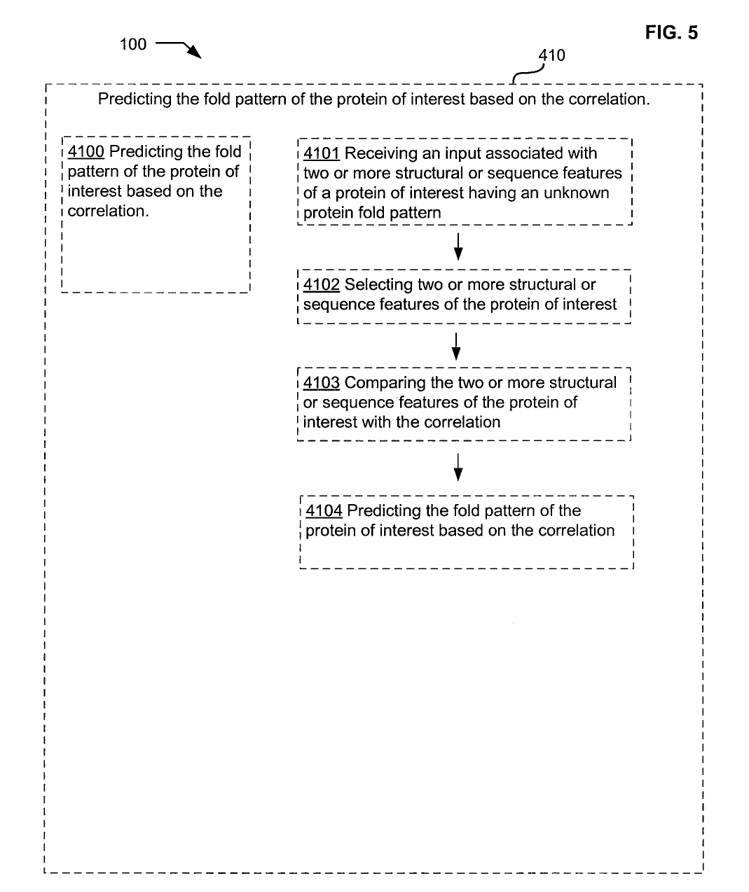

FIG. 5 illustrates embodiments of the operational flow 100 of FIG. 1. FIG. 5 shows illustrative embodiments of the receiving operation 410, predicting the fold pattern of a protein of interest having an unknown fold pattern based on a correlation between (a) two or more structural or sequence features of a plurality of proteins having at least one known fold pattern, and (b) the known fold pattern.

In optional receiving operation 4101, a system receives an input associated with two or more structural or sequence features of a protein of interest having an unknown fold pattern. For example, the two or more structural or sequence features of the protein of interest having an unknown fold pattern may be secondary structural state frequencies of amino acids and solvent accessibility state frequencies of amino acids. In another embodiment, the two or more structural or sequence features of the protein of interest having an unknown fold pattern may be secondary structural state frequencies of dipeptides and solvent accessibility state frequencies of dipeptides. In another embodiment, the two or more structural or sequence features of the protein of interest having an unknown fold pattern may be secondary structural state frequencies of 1-gap dipeptides and solvent accessibility state frequencies of 1-gap dipeptides. In another embodiment, the two or more structural or sequence features of the protein of interest having an unknown fold pattern may be secondary structural state frequencies of amino acids, secondary structural state frequencies of dipeptides, and secondary structural state frequencies of 1-gap dipeptides. In another embodiment, the two or more structural or sequence features of the protein of interest having an unknown fold pattern may be solvent accessibility state frequencies of amino acids, solvent accessibility state frequencies of dipeptides, and solvent accessibility state frequencies of 1-gap dipeptides. In yet another embodiment, the two or more structural or sequence features of the protein of interest having an unknown fold pattern may be secondary structural state frequencies of amino acids, secondary structural state frequencies of dipeptides, solvent accessibility state frequencies of amino acids, and solvent accessibility state frequencies of dipeptides. In yet another embodiment, the two or more structural or sequence features of the protein of interest having an unknown fold pattern may be secondary structural state frequencies of amino acids, secondary structural state frequencies of 1-gap dipeptides, solvent accessibility state frequencies of amino acids, and solvent accessibility state frequencies of 1-gap dipeptides. In another embodiment, the two or more structural or sequence features of the protein of interest having an unknown fold pattern may be secondary structural state frequencies of dipeptides, secondary structural state frequencies of 1-gap dipeptides, solvent accessibility state frequencies of dipeptides, and solvent accessibility state frequencies of 1-gap dipeptides. In another embodiment, the two or more structural or sequence features of the protein of interest having an unknown fold pattern may be secondary structural state frequencies of amino acids, secondary structural state frequencies of dipeptides, secondary structural state frequencies of 1-gap dipeptides, solvent accessibility state frequencies of amino acids, solvent accessibility state frequencies of dipeptides, and solvent accessibility state frequencies of 1-gap dipeptides.

In embodiments described herein, an input that is “associated with” two or more structural or sequence features of a protein of interest having an unknown fold pattern is not limited to a protein's amino acid sequence. It is envisioned that other inputs can be associated with the structural or sequence features of proteins. For example, physical or chemical characteristics of proteins that are associated with the structural or sequence features of a protein could be inputs.

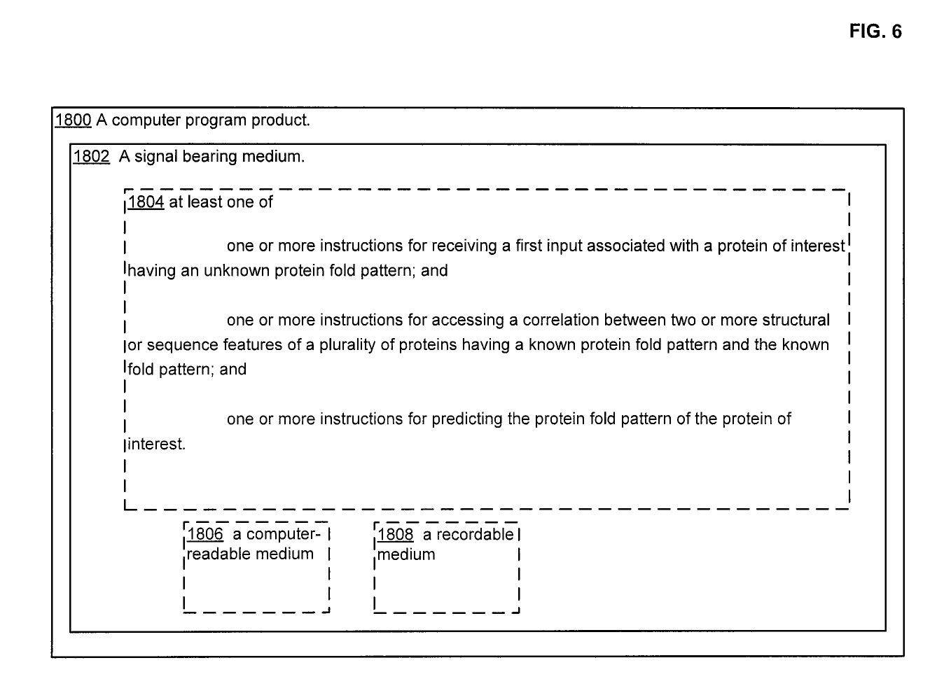

FIG. 6 shows a schematic of a partial view of an illustrative computer program product 1800 that includes a computer program for executing a computer process on a computing device. An illustrative embodiment of the example computer program product is provided using a signal bearing medium 1802, and may include at least one instruction of 1804: one or more instructions for receiving a first input associated with a protein of interest having an unknown protein fold pattern; and one or more instructions for accessing a correlation between two or more structural or sequence features of a plurality of proteins having a known protein fold pattern and the known fold pattern; and one or more instructions for predicting the protein fold pattern of the protein of interest having an unknown fold pattern.

The one or more instructions may be, for example, computer executable and/or logic implemented instructions. In some embodiments, the signal bearing medium 1802 of the one or more computer program 1800 products include a computer readable medium 1806 and a recordable medium 1808. Embodiments may also comprise a communications medium.

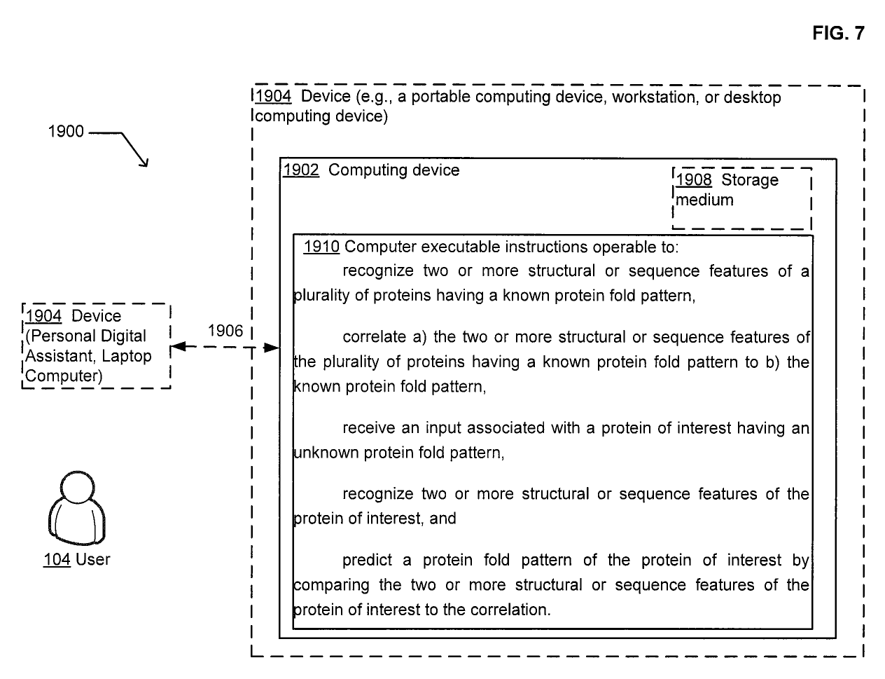

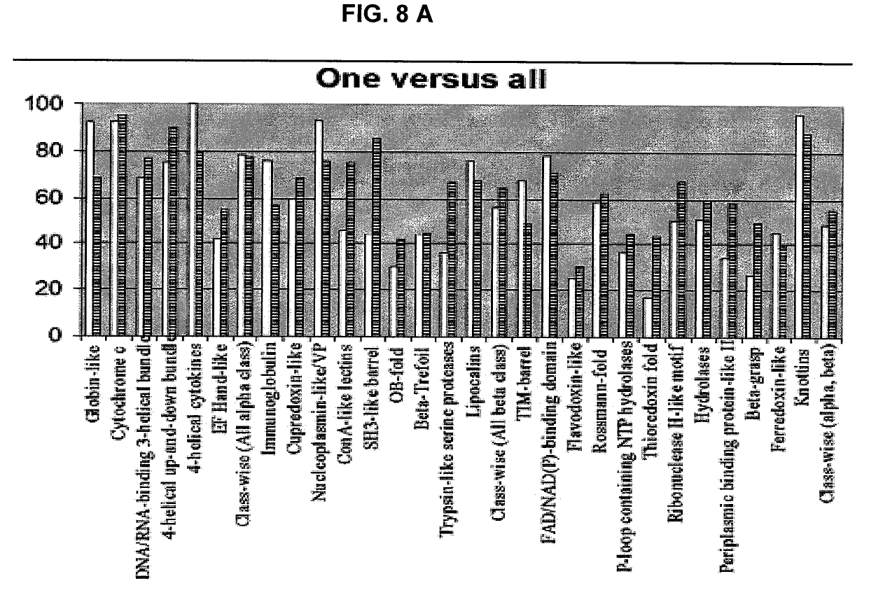

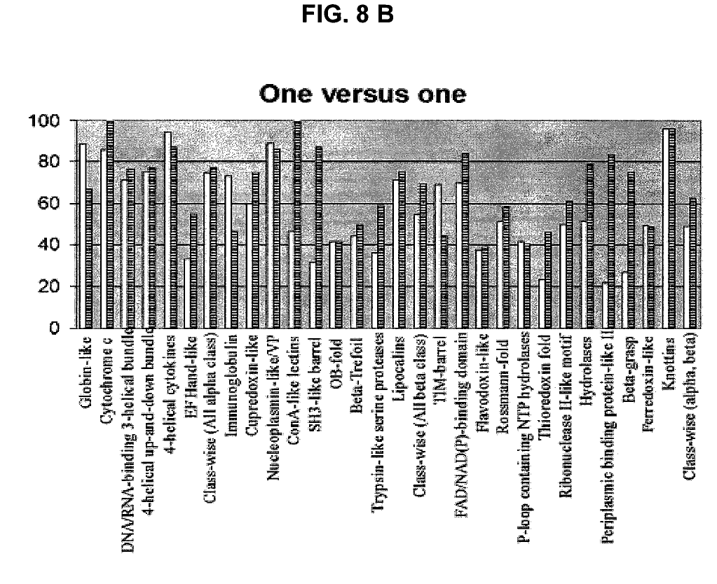

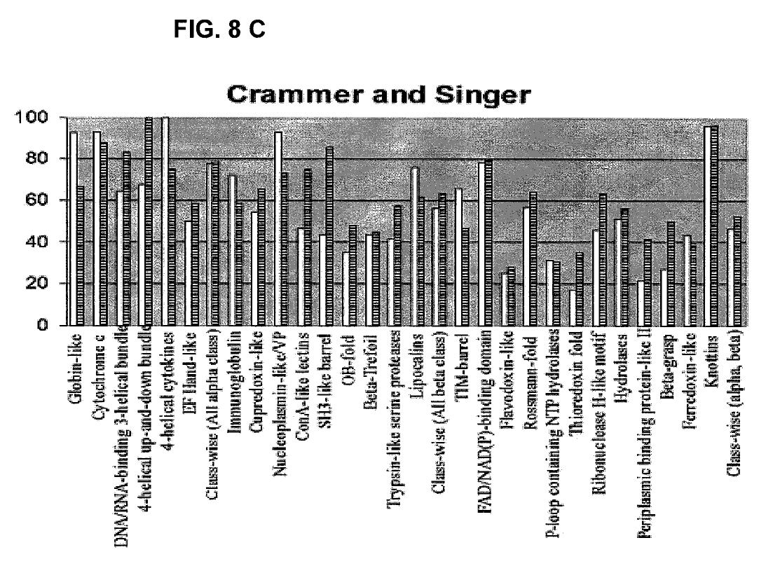

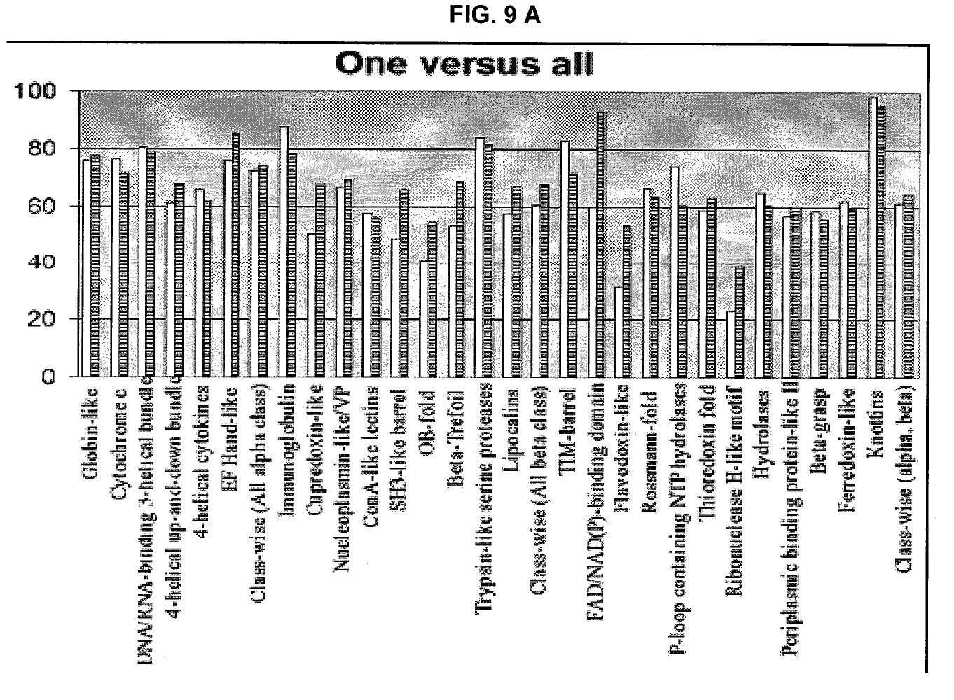

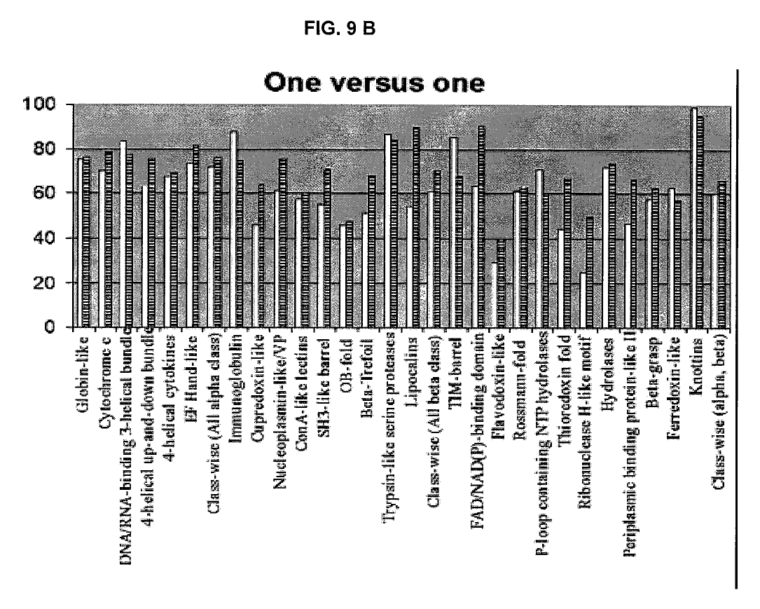

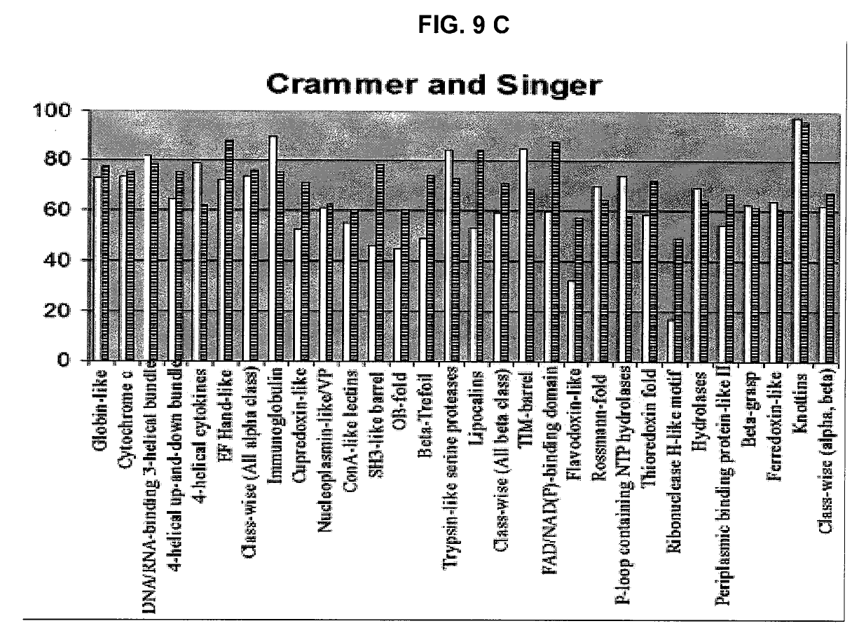

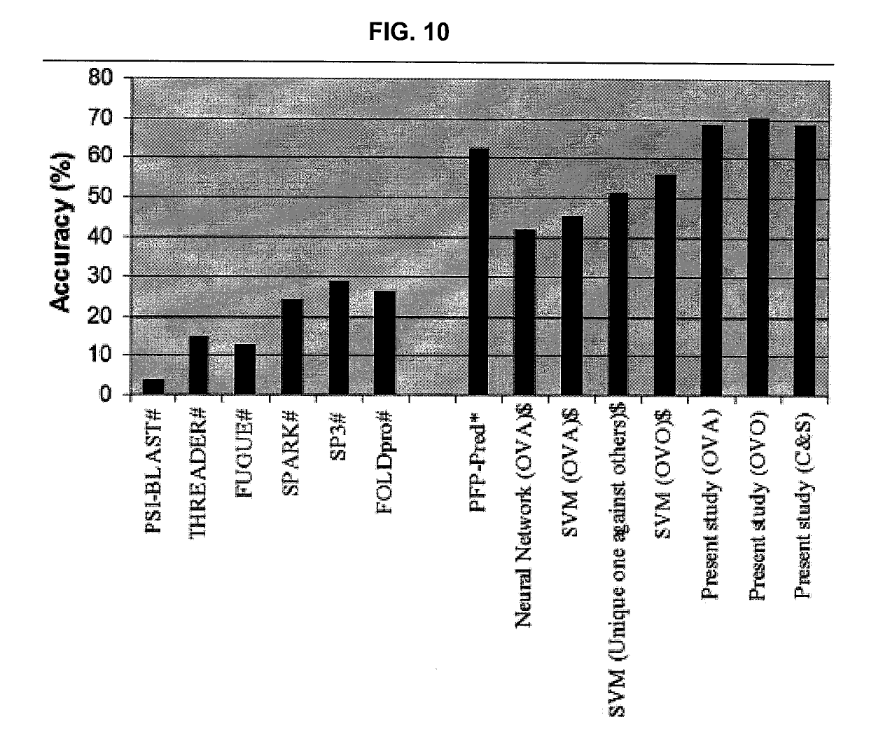

FIG. 7 shows a schematic of an illustrative system 1900 in which embodiments may be implemented. The system 1900 may include a computing system environment. The system 1900 also illustrates a researcher/scientist/investigator/operator 104 using a device 1904, that is optionally shown as being in communication with a computing device 1902 by way of an optional coupling 1906. The optional coupling may represent a local, wide area, or peer-to-peer network, or may represent a bus that is internal to a computing device (e.g. in illustrative embodiments the computing device 1902 is contained in whole or in part within the device 1904). An optional storage medium 1908 may be any computer storage medium.

The computing device 1902 includes one or more computer executable instructions 1910 that when executed on the computing device 1902 cause the computing device 1902 to recognize two or more structural or sequence features of a plurality of proteins having a known protein fold pattern; correlate (a) the two or more structural or sequence features of the plurality of proteins having a known protein fold pattern to (b) the known protein fold pattern; receive an input associated with a protein of interest having an unknown protein fold pattern; recognize two or more structural or sequence features of the protein of interest having an unknown fold pattern, and predict a fold pattern of the protein of interest having an unknown fold pattern by comparing the two or more structural or sequence features of the protein of interest having an unknown fold pattern to the correlation.

In some illustrative embodiments, the computing device 1902 may optionally be contained in whole or in part within the researcher device 1904.

The system 1900 includes at least one computing device (e.g. 1904 and/or 1902) on which the computer-executable instructions 1910 may be executed. For example, one or more of the computing devices (e.g. 1902, 1904) may execute the one or more computer executable instructions 1910 and output a result and/or receive information from the researcher on the same or a different computing device (e.g. 1902, 1904) in order to perform and/or implement one or more of the techniques, processes, or methods described herein, or other techniques.

The computing device (e.g. 1902 and/or 1904) may optionally include one or more of a desktop computer, a workstation computer, a computing system comprised a cluster of processors, a networked computer, a tablet personal computer, a laptop computer, or a personal digital assistant, or any other suitable computing unit. In some embodiments, various computing units may be operable to communicate with any other of the one or more computing devices that may be operable to communicate with a database to access the correlations derived by the methods and systems disclosed herein.

Fold discriminatory features, which are also called sequence- and structure-based features, are listed in Table 1, and can be used to train SVM classifiers. The sequence and structure features of a protein of interest having an unknown fold pattern can then be analyzed by SVM to predict the fold pattern of a protein of interest having an unknown fold pattern.

In some embodiments, two structural or sequence features of a plurality of proteins having a known fold pattern, can be used in SVM-training, for example, features 4+7; features 5+8; or features 6+9 (see Table 1). In other embodiments, more than two structural or sequence features can be used for SVM training, for example, features 4+5+6; features 7+8+9; features 4+7+5+8; features 4+7+6+9; features 5+8+6+9; or features 4+7+5+8+6+9. These embodiments are not limiting; different combinations of structural or sequence features used in SVM training are envisioned.

Similarly, after a system has been trained using SVM classification to correlate a) two or more structural or sequence features of a plurality of proteins having a known fold pattern, to b) the fold pattern, then the fold pattern of a protein of interest having an unknown fold pattern can be predicted by comparing two or more structural or sequence features of the protein of interest having an unknown fold pattern to the correlation. Similar to SVM training, the two or more structural or sequence features of the protein of interest having an unknown fold pattern used to predict the fold pattern of a protein of interest having an unknown fold pattern can be two or more of those listed in Table 1. For example, features 4+7; features 5+8; or features 6+9 (see Table 1). In other embodiments, the two or more structural or sequence features can be for example, features 4+5+6; features 7+8+9; features 4+7+5+8; features 4+7+6+9; features 5+8+6+9; or features 4+7+5+8+6+9. These embodiments are not limiting; different combinations of structural or sequence features used in compare the two or more structural or sequence features of the protein of interest having an unknown fold pattern to the correlation training are envisioned.

Accordingly, in various embodiments, the two or more structural or sequence features of the plurality of proteins having a known protein fold pattern, and/or the protein of interest having an unknown fold pattern, can be selected from the group consisting of: amino acid composition; first order amino acid pair (dipeptide) composition; second order amino acid pair (1-gap dipeptide) composition; secondary structural state frequencies of amino acids; secondary structural state frequencies of dipeptides; secondary structural state frequencies of 1-gap dipeptides; solvent accessibility state frequencies of amino acids; solvent accessibility state frequencies of dipeptides; and solvent accessibility state frequencies of 1-gap dipeptides.

In another embodiment, the two or more structural or sequence features of the plurality of proteins having a known protein fold pattern, and/or the protein of interest having an unknown fold pattern are secondary structural state frequencies of amino acids and solvent accessibility state frequencies of amino acids.

In another embodiment, the two or more structural or sequence features of the plurality of proteins having a known protein fold pattern, and/or the protein of interest having an unknown fold pattern are secondary structural state frequencies of dipeptides and solvent accessibility state frequencies of dipeptides.

In another embodiment, the two or more structural or sequence features of the plurality of proteins having a known protein fold pattern, and/or the protein of interest having an unknown fold pattern are secondary structural state frequencies of 1-gap dipeptides and solvent accessibility state frequencies of 1-gap dipeptides.

In another embodiment, the two or more structural or sequence features of the plurality of proteins having a known protein fold pattern, and/or the protein of interest having an unknown fold pattern are secondary structural state frequencies of amino acids, secondary structural state frequencies of dipeptides, and secondary structural state frequencies of 1-gap dipeptides.

In another embodiment, the two or more structural or sequence features of the plurality of proteins having a known protein fold pattern, and/or the protein of interest having an unknown fold pattern solvent accessibility state frequencies of amino acids, are solvent accessibility state frequencies of dipeptides and solvent accessibility state frequencies of 1-gap dipeptides.

In yet another embodiment, the two or more structural or sequence features of the plurality of proteins having a known protein fold pattern, and/or the protein of interest having an unknown fold pattern are secondary structural state frequencies of amino acids, secondary structural state frequencies of dipeptides, solvent accessibility state frequencies of amino acids, and solvent accessibility state frequencies of dipeptides.

In yet another embodiment, the two or more structural or sequence features of the plurality of proteins having a known protein fold pattern, and/or the protein of interest having an unknown fold pattern are secondary structural state frequencies of amino acids, secondary structural state frequencies of 1-gap dipeptides, solvent accessibility state frequencies of amino acids, and solvent accessibility state frequencies of 1-gap dipeptides.

In another embodiment, the two or more structural or sequence features of the plurality of proteins having a known protein fold pattern, and/or the protein of interest having an unknown fold pattern are secondary structural state frequencies of dipeptides, secondary structural state frequencies of 1-gap dipeptides, solvent accessibility state frequencies of dipeptides, and solvent accessibility state frequencies of 1-gap dipeptides.

In another embodiment, the two or more structural or sequence features of the plurality of proteins having a known protein fold pattern, and/or the protein of interest having an unknown fold pattern are secondary structural state frequencies of amino acids, secondary structural state frequencies of dipeptides, secondary structural state frequencies of 1-gap dipeptides, solvent accessibility state frequencies of amino acids, solvent accessibility state frequencies of dipeptides, and solvent accessibility state frequencies of 1-gap dipeptides.

TABLE 1
Different features along with their dimensions, used for training SVM classifiers

| | | |
|---|---|---|
| Feature Index | Feature | Dimensions |

Individual features
Sequence-based features

| | | |
|---|---|---|
| 1 | Amino acid composition | 20 |
| 2 | First order amino acid pair (dipeptide) composition | 400 |
| 3 | Second order amino acid pair (1-gap dipeptide) composition | 400 |

Structural-based features

| | | |
|---|---|---|
| 4 | Secondary structural state frequencies of amino acids | 60 |
| 5 | Secondary structural state frequencies of dipeptides | 1200 |
| 6 | Secondary structural state frequencies of 1-gap dipeptides | 1200 |
| 7 | Solvent accessibility state frequencies of amino acids | 40 |
| 8 | Solvent accessibility state frequencies of dipeptides | 1200 |
| 9 | Solvent accessibility state frequencies of 1-gap dipeptides | 1200 |

Combination of features

| | | |
|---|---|---|
| 10 | Feature 4 + Feature 7 | 100 |
| 11 | Feature 5 + Feature 8 | 2400 |
| 12 | Feature 6 + Feature 9 | 2400 |
| 13 | Feature 4 + Feature 5 + Feature 6 | 2460 |
| 14 | Feature 7 + Feature 8 + Feature 9 | 2440 |
| 15 | Feature 4 + Feature 7 + Feature 5 + Feature 8 | 2500 |
| 16 | Feature 4 + Feature 7 + Feature 6 + Feature 9 | 2500 |
| 17 | Feature 5 + Feature 8 + Feature 6 + Feature 9 | 4800 |
| 18 | Feature 4 + Feature 7 + Feature 5 + Feature 8 + Feature 6 + Feature 9 | 4900 |

The performance of fold classification by SVM can be evaluated by computing overall accuracy (O), sensitivity (Sn) and specificity (Sp). Overall accuracy is a commonly used parameter for assessing the global performance of a multi-class problem (Ding and Dubchak, 2001; Pierleoni et al., 2006), and is defined as the number of instances correctly predicted over the total number of instances in the test set:

$$Q = \frac{{\sum }_{i} {z}_{i}}{N} \times 100$$

where N is the total number of proteins (instances) in the test set, and zᵢ are the true positives. Sensitivity and specificity, as described above, can be calculated using formulae:

$$Sensitivity ( Sn ) = \frac{( TP \times 100 )}{( TP + FN )}$$

$$Specificity ( Sp ) = \frac{( TP \times 100 )}{( TP + FP )}$$

where TP, FN and FP are the number of true positives, false negatives and false positives, respectively.

n-fold cross-validation is generally used to check the generalization and stability of a protein fold determination method (Bhasin and Raghava, 2004; Goutte, 1997; Wang et al., 2006).

### EXAMPLES

### Example 1

### Fold Discriminatory Potential

The fold discriminatory potential of a number of sequence- and structure-based features were investigated using SVM. The study revealed that the secondary structural and solvent accessibility state frequencies of amino acids and amino acid pairs collectively provided excellent fold discrimination accuracy. The newly developed SVM-based approach presented in this example was stable and outperformed the other available fold discrimination methods. Therefore, protein fold discrimination using SVM can be used for fold-wise classification of unknown proteins (i.e., predicting the fold pattern of proteins of interest having unknown fold patterns) that are discovered as products of various genomes.

In general, a multi-class problem is computationally more intensive than a binary problem. Since protein fold recognition (and prediction) is typically a multi-class problem, multi-class methods have typically been used, namely, all-together method (referred to as Crammer and Singer method) and the two binary classification-based methods: one versus all and one versus one. One versus all and one versus one methods have been used earlier for protein fold recognition (Ding and Dubchak, 2001).

All SVM computations disclosed herein were carried out using LIBSVM (Chang and Lin, 2001). The one versus one implementation of LIBSVM 2.83 main code, one versus all implementation of LIBSVM error-correcting code, and Crammer and Singer method implementation of BSVM 2.0 were used. Although LIBSVM provides a choice of in-built kernels, such as Linear, Polynomial, Radial basis function (RBF) and Gaussian, RBF kernel was used for this study. The SVMs were trained using different values of the cost parameter C=[2¹¹, 2¹⁰, . . . , 2⁻³] and kernel parameter γ=[2⁻³, 2⁻², . . . , 2⁻¹¹].

To train SVM, investigations were performed on two datasets having proteins with known fold patterns: (a) the Ding and Dubchak dataset (D-B dataset), which was same as that used in earlier studies (Ding and Dubchak, 2001; Shen and Chou, 2006), and (b) the extended D-B dataset, which was formed by further populating the D-B dataset in (a) above with additional proteins having known fold pattern(s).

The D-B dataset contained 311 and 383 proteins for training and testing, respectively. This dataset was formed such that, in the training protein set, no two proteins had more than 35% sequence identity to each other and each fold had seven or more representative proteins; and in the test set, proteins had <40% sequence identity to each other and not more than 35% identity to the proteins of the training set (Ding and Dubchak, 2001). According to SCOP classification (Murzin et al., 1995), the proteins used for training and testing belonged to 27 different folds representing all major structural classes: all α, all β, α/β, α+β, and small proteins.

The extended D-B dataset was formed by merging training and testing datasets of the D-B dataset, and further populating each fold with additional protein examples chosen from ASTRAL SCOP 1.71 (Chandonia et al., 2004) where sequences have <40% identity to each other. This dataset included 2554 proteins belonging to 27 folds.

The sequence- and structure-based features utilized, and which are described above, are listed in Table 1.

For structure-based features, predicted secondary structural information was used as the basis for all the calculations. The predictions were made using PSIPRED (McGuffin et al., 2000), and only those with confidence level ≧1 were considered for calculations.

For secondary structural state frequencies of amino acid pairs, an amino acid pair was considered as found in helix or β-strand, only if both the residues were found in helix or strand, respectively. Otherwise, the pair was considered as found in coil.

For solvent accessibility state (B, E) frequencies of amino acids, predicted solvent accessibility states were used for calculating these frequencies. ACCpro (Cheng et al., 2005) was used for predicting the solvent accessibility states of amino acid residues (cut off value for relative solvent accessibilities were ≦10% and >10% for buried (B) and exposed (E), respectively).

For solvent accessibility state frequencies of amino acid pairs, an amino acid pair was considered as buried (B), or exposed (E), only if both the residues were found buried or exposed, respectively. All other pairs were considered as partially buried (I).

The performance of fold classification by SVM was evaluated by computing overall accuracy (O), sensitivity (Sn) and specificity (Sp) as set forth in the equations described above.

The n-fold cross-validation is generally used to check the generalization and stability of a method (Bhasin and Raghava, 2004; Goutte, 1997; Wang et al., 2006). In this study, 2-fold cross-validation was performed using the D-B dataset and 5-fold cross-validation using the extended D-B dataset. The classification performance of input features was also evaluated using a naïve Bayes classifier downloaded from the internet, and was trained with default parameters using the same input features as were used in SVM. The performance was evaluated using 2-fold and 5-fold cross-validation for D-B and extended D-B dataset, respectively.

Preliminary studies were conducted to test the usefulness of the different orders (n) ranging from 1 to 12, of amino acid pairs. These preliminary studies revealed that the amino acid pairs with the first (n=1) and second (n=2) orders resulted in acceptable prediction accuracies. Therefore, the first and second order of amino acid pairs were considered.

### Example 2

### Twofold Cross-Validation Studies Using D-B Dataset

Individual fold discriminatory potentials of the sequence and the structure-based features, shown in Table 1, were analyzed. The prediction accuracies yielded by the various features for the three multi-class methods and their corresponding values of C and γ were shown. Among the nine individual features evaluated in this study, secondary structural state frequencies of amino acids (Feature 4) gave the highest overall Q_{cv} (2-fold cross-validation accuracy) value of 57% (Table 2). The fold discriminatory potential of different combinations of the features was also examined. Of these, Feature 10—i.e., the combination of secondary structural state and solvent accessibility state frequencies of amino acids, resulted in the highest 2-fold accuracy of 60% (Table 2).

TABLE 2
The overall 2-fold cross-validation accuracies
obtained for three multi-class methods-(a) one versus all, (b)
one versus one and (c) Crammer and Singer

| Individual features | | | | Combination of features | | | |
|---|---|---|---|---|---|---|---|
| Feature | OVA | OVO | C&S | Feature | OVA | OVO | C&S |
| index | Qcv | Qcv | Qcv | index | Qcv | Qcv | Qcv |
| 1 | 49.0 | 48.8 | 48.8 | 10 | 60.5 | 59.5 | 59.5 |
| 2 | 47.5 | 47.3 | 46.5 | 11 | 53.3 | 47.8 | 52.0 |
| 3 | 50.3 | 48.9 | 47.6 | 12 | 55.5 | 49.2 | 54.4 |
| 4 | 56.9 | 54.2 | 55.7 | 13 | 54.7 | 51.2 | 52.5 |
| 5 | 49.2 | 48.6 | 49.5 | 14 | 55.7 | 48.5 | 54.7 |
| 6 | 49.9 | 48.9 | 49.3 | 15 | 56.0 | 50.8 | 54.4 |
| 7 | 52.0 | 49.0 | 51.5 | 16 | 58.8 | 51.6 | 57.4 |
| 8 | 51.1 | 46.0 | 50.1 | 17 | 55.9 | 46.8 | 55.7 |
| 9 | 52.5 | 47.0 | 51.4 | 18 | 54.0 | 46.0 | 55.0 |

The SVM training and testing were carried out twice (2-fold cross-validation) for D-B dataset. In the first trial, training was done on the training set and validation on the test set. In the second trial, training was done on the test set and validation on train set. The average of the accuracies obtained in the two runs is given as the 2-fold cross-validation accuracy (Q_{cv}). The best Q_{cv} obtained for a multi-class method is shown in bold.

The sensitivity and specificity values of the best classifier set Feature10, as obtained by the three multi-class methods, are shown in FIG. 1. As shown in the figure, the sensitivity and specificity values did not remain the same for all the folds. In general, folds that are mostly a-helical, such as globin-like and cytochrome c, show high sensitivity and specificity. The average prediction accuracy (i.e. sensitivity) obtained for ‘all α class’ folds was about 78% as compared to about 56% obtained for ‘all β class’ folds. This difference in prediction accuracies between the two classes of folds can be attributed to the accuracies associated with the prediction of secondary structures and solvent accessibilities of amino acids and amino acid pairs present in these folds. In general, α-helices are predicted with better accuracies than the β-strands (Rost and Sander, 1993 and Table 3).

TABLE 3
Discrepancy (error) in secondary structural state
(helix, strand) prediction and solvent accessibility state
(buried) prediction for different folds.

| Fold | Eₕ | Eₛ | E_{b} | DOM_{mdp} |
|---|---|---|---|---|
| All α class | | | | |
| Globin-like | 5.5 | — | 19.4 | 0.0 |
| Cytochrome c | 12.3 | — | 34.7 | 31.2 |
| DNA/RNA-binding 3- | 10.5 | — | 33.8 | 34.4 |
| helical bundle | | | | |
| 4-helical up-and-down | 7.9 | — | 29.8 | 13.3 |
| bundle | | | | |
| 4-helical cytokines | 11.5 | — | 35.5 | 0.0 |
| EF Hand-like | 11.5 | — | 25.7 | 20.0 |
| Class-wise average | 9.9 | | 29.8 | 16.5 |
| All β class | | | | |
| Immunoglobulin-like β- | — | 17.8 | 32.8 | 43.2 |
| sandwich | | | | |
| Cupredoxin-like | — | 16.9 | 26.3 | 47.6 |
| Nucleoplasmin-like/VP | — | 27.1 | 29.8 | 0.0 |
| ConA-like | — | 18.9 | 16.0 | 15.4 |
| lectins/glucanases | | | | |
| SH3-like barrel | — | 17.6 | 40.9 | 12.5 |
| OB-fold | — | 21.3 | 32.7 | 37.5 |
| Beta-Trefoil | — | 18.1 | 30.1 | 16.7 |
| Trypsin-like serine proteases | — | 25.3 | 16.7 | 0.0 |
| Lipocalins | — | 9.6 | 24.8 | 0.0 |
| Class-wise average: α, β | | 19.2 | 27.8 | 19.2 |
| (α/β, α ± β, and small | | | | |
| proteins) | | | | |
| TIM beta/alpha-barrel | 13.4 | 24.0 | 10.5 | 33.8 |
| FAD/NAD(P)-binding | 16.7 | 23.6 | 25.6 | 82.6 |
| domain | | | | |
| Flavodoxin-like | 13.6 | 13.7 | 14.2 | 54.2 |
| NAD(P)-binding Rossmann | 7.7 | 16.5 | 21.8 | 72.5 |
| P-loop containing NTH | 13.6 | 20.0 | 18.3 | 36.4 |
| Thioredoxin fold | 10.7 | 10.5 | 23.7 | 47.1 |
| Ribonuclease H-like motif | 15.2 | 23.2 | 22.6 | 63.6 |
| Hydrolases | 17.5 | 22.4 | 8.3 | 16.7 |
| Periplasmic binding protein- | 7.9 | 14.7 | 5.5 | 6.7 |
| like II | | | | |
| β-grasp (ubiquitin-like) | 21.6 | 17.2 | 28.8 | 40.0 |
| Ferredoxin-like | 16.8 | 27.7 | 33.8 | 30.0 |
| Knottins | 55.5 | 55.2 | 51.2 | 37.5 |
| Class-wise average | 17.5 | 22.4 | 22.0 | 43.4 |

The errors were calculated by comparing the assigned and predicted states. Eₕ and Eₛ represent the fold-wise percentage error in helix and strand prediction. E_{b} represents the fold-wise percentage error in buried state prediction. The last column shows percentage of domains, which are part of multi-domain proteins (MDP) in each fold (DOM_{mdp}).

The methods used for secondary structure and solvent accessibilities were, respectively, PSIPRED and ACCpro which have prediction accuracies of about 78% (McGuffin et al., 2000) and about 77% (Cheng et al., 2005), respectively. Because the structures for the protein domains in the D-B dataset were known, the secondary structural states were identified using SSTRUC (Smith, 1989). The solvent accessibilities were calculated using PSA (Sali, 1991) and were compared with the predictions (Table 3). Most of the low performing folds showed marked errors in their predicted secondary structural states. For example, the OB-fold showed about 22% error in strand prediction (Eₛ); trypsin-like serine proteases fold, about 25% error in strand prediction; ribonuclease H-like motif fold, about 15% error in helix prediction; and about 23% error in strand prediction.

Similarly, the low performing folds showed significant errors in the prediction of solvent accessibility states of the residues. Failure to predict the correct number of buried residues can arise in the case of domains that form parts of multi-domain proteins. In such cases, the solvent accessibility prediction program does not give proper prediction because contact residues between domains, which are actually buried, are predicted as exposed. The percentage of such domains were calculated, which are part of multi-domain proteins in each fold (Table 3). Most of the folds characterized by the domains from multi-domain proteins gave rise to low prediction accuracies.

In addition to the influence of incorrectly predicted features, SVM training can also become error prone due to the sparseness of the dataset used. It is known that performance of the SVM depends on the size of the dataset used for training because SVM learns from the known examples. The greater the number of known examples (for both positives and negatives) available for learning, the better would be the model. Many folds are sparsely represented in the D-B dataset. For example, folds such as the immunoglobulin-like β-sandwich and TIM-barrel show good sensitivity but poor specificity. These are the most populated folds in the D-B dataset. Generally, SVM training in such cases becomes biased towards populous folds labeled as positive rather than lesser populated folds labeled as negative. Accordingly, some proteins that do not belong to the populous folds get classified as positive rather than lesser populated folds labeled as negative. Hence, some proteins that do not belong to the populous folds get classified as positives.

### Example 3

### Fivefold Cross-Validation Studies Using Extended D-B Dataset

In order to remove any bias due to inadequate data, the D-B dataset was subsequently populated by adding representatives taken from ASTRAL SCOP 1.71 (Chandonia et al., 2004). The new extended training dataset, referred to as the extended D-B dataset, was almost four times larger in size than was the initial D-B dataset. The extended dataset was used to perform 5-fold cross-validation by randomly dividing the dataset into five equal size sets (I, II, III, IV and V). In each round of cross-validation, training was carried out using four sets, and fold testing was conducted using the remaining set. The prediction accuracies achieved by the various features for the three multi-class methods and their corresponding values of C and γ were known.

Among the individual features tested, the secondary structural state frequencies of amino acids (Feature 4) gave the best 5-fold accuracy of 65% (Table 4). This result obtained is higher than the best accuracy (62%) reported in the literature by the Ensemble classifier approach PFP-Pred (Shen and Chou, 2006). Among the feature combinations, Feature 15 (combination of secondary structural state and solvent accessibility state frequencies of amino acids and first-order amino acid pairs), gave the highest accuracy of 70.5% (Table 4). The feature combination, Feature10, which showed the highest accuracy in 2-fold cross validation studies, achieved a 5-fold accuracy of about 69%.

TABLE 4
The overall 5-fold cross-validation accuracy (Q_{cv})
along with SD (enclosed within parentheses) obtained for
all the features using
three multi-class methods: one versus all, one versus one
and Crammer and Singer

| | OVA | OVO | C&S |
|---|---|---|---|
| Feature index | Qcv | Qcv | Qcv |
| 1 | 42.7 (0.9) | 44.1 (0.8) | 43.0 (1.3) |
| 2 | 48.9 (1.9) | 50.5 (1.0) | 45.0 (1.9) |
| 3 | 48.8 (1.4) | 50.4 (0.7) | 43.1 (1.5) |
| 4 | 64.9 (1.1) | 65.2 (1.1) | 63.4 (1.4) |
| 5 | 60.3 (1.0) | 63.7 (0.8) | 56.3 (1.8) |
| 6 | 58.8 (0.4) | 62.5 (1.5) | 53.9 (0.6) |
| 7 | 54.2 (2.0) | 54.3 (1.3) | 53.9 (1.6) |
| 8 | 57.0 (2.0) | 58.3 (1.5) | 54.4 (2.1) |
| 9 | 56.9 (1.7) | 59.0 (1.8) | 54.1 (1.5) |
| 10 | 68.7 (1.7) | 68.7 (2.5) | 68.8 (1.9) |
| 11 | 65.2 (1.5) | 68.3 (1.3) | 63.0 (1.3) |
| 12 | 63.4 (1.3) | 67.4 (1.7) | 61.2 (0.6) |
| 13 | 66.0 (1.5) | 68.7 (1.3) | 62.4 (1.6) |
| 14 | 63.6 (1.5) | 64.3 (1.2) | 62.7 (3.5) |
| 15 | 67.7 (2.0) | 70.5 (0.7) | 65.3 (2.1) |
| 16 | 66.2 (1.6) | 70.3 (1.2) | 64.1 (1.2) |
| 17 | 65.6 (2.0) | 67.6 (1.6) | 64.0 (1.5) |
| 18 | 66.4 (1.2) | 68.4 (0.6) | 65.8 (1.9) |

In the 5-fold cross-validation, the extended D-B dataset was randomly divided into five equal size sets. In each round of cross-validation, four sets were used for training, and the remaining set was used for testing. The best Q_{cv} obtained for a multi-class method is shown in bold.

The sensitivities and specificities obtained for the different folds are shown in FIG. 2. As can be seen from the figure, the prediction accuracies for many folds (i.e. EF Hand-like, immunoglobulin-like β-sandwich, TIM-barrel, trypsin-like serine proteases, etc.), improved significantly compared to the results obtained from the 2-fold cross-validation studies described above. This result demonstrated that dataset size influenced the quality of SVM training, and thus, the accuracy of protein fold prediction.

The extended dataset also increased the specificity values of the populous folds, which showed poor specificity in 2-fold cross-validation studies described above. This result indicated that poor specificity in 2-fold cross-validation studies was due to the lower number of training proteins in the D-B dataset.

The classification accuracy at the superfamily level was calculated. Superfamilies having at least 20 proteins in the extended D-B dataset were selected for the study. There were a total of 33 such superfamilies in the extended D-B dataset. A 5-fold accuracy of 74.2% was obtained. The sensitivities and specificities obtained for different superfamilies were shown.

Finally, the generalization performance of SVM was estimated using the leave-one-out error estimate commonly used for this purpose. The leave-one-out error estimate was calculated for Feature 10 and Feature 15 using the extended D-B dataset, and the results were known. The leave-one-out error estimate obtained was very similar to average error (100−Q_{cv}) obtained for the 5-fold cross-validation. Furthermore, the number of support vectors in the model further strengthens the fact that the SVM is not over-trained for any specific dataset. As described above, prediction accuracies were also calculated using a naïve Bayes classifier for the same input features. It was found that SVM performance is superior to the accuracies obtained using naïve Bayes classifier.

### Comparison of Multi-Class Methods

It has been argued that one versus one method performs better than the one versus all multi-class method (Allwein et al., 2000; Fumkranz, 2002; Hsu and Lin, 2002). However, the data generated revealed that all the three multi-class methods yielded similar overall accuracies, sensitivities and specificities (see Tables 2 and 4, and FIGS. 1 and 2), indicating that the performance of SVM for the present set of features was independent of the type of multi-class method used but dependent on the types of discriminatory features as well as the size of the dataset used for training. It is, however, worth noting that one versus all method was slower than the one versus one and Crammer and Singer methods, especially for large dimensional features such as the features that were used in the present Example, and hence, any one of the latter methods is more useful in terms of execution time.

### Example 4

### Comparison with the Other Fold Recognition Methods

The performance of the disclosed approach was compared with that of other taxonomic fold recognition methods reported in literature; details are shown in FIG. 3. The prediction accuracies of the template-based fold recognition methods are also shown as reported in the literature. As evident from FIG. 3, the prediction accuracy obtained was surprisingly found to be about 8% higher than the best available method, PFP-Pred. The strikingly better performance of the disclosed SVM fold prediction approach can be attributed to the more sensitive and specific fold discriminatory features as well as better trained fold-specific SVM.

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuits (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

All references, including but not limited to patents, patent applications, and non-patent literature are hereby incorporated by reference herein in their entirety.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

We claim:

1. A method comprising:
receiving an input associated with two or more structural or sequence features of a plurality of proteins having a known protein fold pattern, and
training a system to correlate the two or more structural or sequence features to the known protein fold pattern such that the system is trained to predict one or more protein fold patterns of a protein of interest having an unknown fold pattern.

2. The method of claim 1, wherein training the system comprises:
performing Support Vector Machine (SVM) analysis on a plurality of proteins having a known protein fold pattern.

3. The method of claim 2 wherein Support Vector Machine (SVM) analysis comprises:
selecting two or more structural or sequence features of the plurality of proteins having a known protein fold pattern; and
correlating a) the two or more structural or sequence features of the plurality of proteins having a known protein fold pattern to b) the known protein fold pattern.

4. The method of claim 3 wherein the plurality of proteins are each from about 100 to about 400 amino acids in length.

5. The method of claim 1 wherein the two or more structural or sequence features of the plurality of proteins having a known protein fold pattern are selected from the group consisting of: amino acid composition; first order amino acid pair (dipeptide) composition; second order amino acid pair (1-gap dipeptide) composition; secondary structural state frequencies of amino acids; secondary structural state frequencies of dipeptides; secondary structural state frequencies of 1-gap dipeptides; solvent accessibility state frequencies of amino acids; solvent accessibility state frequencies of dipeptides; and solvent accessibility state frequencies of 1-gap dipeptides.

6. The method of claim 5 wherein the two or more structural or sequence features are secondary structural state frequencies of amino acids and solvent accessibility state frequencies of amino acids.

7. The method of claim 5 wherein the two or more structural or sequence features are secondary structural state frequencies of dipeptides and solvent accessibility state frequencies of dipeptides.

8. The method of claim 5 wherein the two or more structural or sequence features are secondary structural state frequencies of 1-gap dipeptides and solvent accessibility state frequencies of 1-gap dipeptides.

9. The method of claim 5 wherein the two or more structural or sequence features are secondary structural state frequencies of amino acids, secondary structural state frequencies of dipeptides, and secondary structural state frequencies of 1-gap dipeptides.

10. The method of claim 5 wherein the two or more structural or sequence features are solvent accessibility state frequencies of amino acids, solvent accessibility state frequencies of dipeptides, and solvent accessibility state frequencies of 1-gap dipeptides.

11. The method of claim 5 wherein the two or more structural or sequence features are secondary structural state frequencies of amino acids, secondary structural state frequencies of dipeptides, solvent accessibility state frequencies of amino acids, and solvent accessibility state frequencies of dipeptides.

12. The method of claim 5 wherein the two or more structural or sequence features are secondary structural state frequencies of amino acids, secondary structural state frequencies of 1-gap dipeptides, solvent accessibility state frequencies of amino acids, and solvent accessibility state frequencies of 1-gap dipeptides.

13. The method of claim 5 wherein the two or more structural or sequence features are secondary structural state frequencies of dipeptides, secondary structural state frequencies of 1-gap dipeptides, solvent accessibility state frequencies of dipeptides, and solvent accessibility state frequencies of 1-gap dipeptides.

14. The method of claim 5 wherein the two or more structural or sequence features are secondary structural state frequencies of amino acids, secondary structural state frequencies of dipeptides, secondary structural state frequencies of 1-gap dipeptides, solvent accessibility state frequencies of amino acids, solvent accessibility state frequencies of dipeptides, and solvent accessibility state frequencies of 1-gap dipeptides.

15. The method of claim 1 further comprising:
receiving an input associated with two or more structural or sequence features of the protein of interest having an unknown fold pattern.

16. The method of claim 15, further comprising:
predicting the protein fold pattern of a protein of interest having an unknown fold pattern using the system.

17. The method of claim 15 wherein receiving the input associated with two or more structural or sequence features of a protein of interest having an unknown protein fold pattern comprises:
receiving the amino acid sequence of the protein of interest having an unknown fold pattern.

18. The method of claim 17 wherein the protein of interest having an unknown fold pattern is from about 100 to about 400 amino acids in length.

19. The method of claim 16 wherein predicting one or more protein fold patterns of the protein of interest having an unknown fold pattern based on the correlation comprises:
selecting two or more structural or sequence features of the protein of interest having an unknown fold pattern;
comparing the two or more structural or sequence features of the protein of interest having an unknown fold pattern with the correlation; and
predicting the protein fold pattern of the protein of interest having an unknown fold pattern based on the correlation.

20. The method of claim 19 wherein the protein fold pattern prediction accuracy is at least 60%.

21. The method according to claim 15 wherein the two or more structural or sequence features of the protein of interest having an unknown fold pattern and the plurality of proteins having a known fold pattern are selected from the group consisting of: amino acid composition; first order amino acid pair (dipeptide) composition; second order amino acid pair (1-gap dipeptide) composition; secondary structural state frequencies of amino acids; secondary structural state frequencies of dipeptides; secondary structural state frequencies of 1-gap dipeptides; solvent accessibility state frequencies of amino acids; solvent accessibility state frequencies of dipeptides; and solvent accessibility state frequencies of 1-gap dipeptides.

22. The method according to claim 15, wherein the protein of interest having an unknown protein fold pattern and the plurality of proteins having a known protein fold pattern are each from about 80 to about 350 amino acids in length.

23. A computer program comprising:
a signal bearing medium bearing at least one of
one or more instructions for receiving a first input associated with a protein of interest having an unknown protein fold pattern; and
one or more instructions for predicting the protein fold pattern of the protein of interest having an unknown protein fold pattern.

24. The computer program of claim 23, wherein the first input associated with a protein of interest having an unknown protein fold pattern is the amino acid sequence of the protein of interest having an unknown fold pattern.

25. The computer program of claim 23, further comprising one or more instructions for predicting the protein fold pattern of the protein of interest having an unknown fold pattern by:
selecting two or more structural or sequence features of the protein of interest having an unknown fold pattern;
comparing the two or more structural or sequence features of the protein of interest having an unknown fold pattern with the correlation; and
predicting the protein fold pattern of the protein of interest having an unknown fold pattern based on the correlation.

26. A system comprising:
a computing device; and
instructions that when executed on the hardware or software cause the hardware or software to a) recognize two or more structural or sequence features of a plurality of proteins having a known protein fold pattern, and b) correlate the two or more structural or sequence features of the plurality of proteins having a known protein fold pattern to the known protein fold pattern.

27. The system of claim 26, wherein the instructions when executed on the hardware or software cause the hardware or software further to c) receive an input associated with a protein of interest having an unknown protein fold pattern, and d) recognize two or more structural or sequence features of the protein of interest having an unknown fold pattern.

28. The system of claim 27, wherein the instructions when executed on the hardware or software cause the hardware or software further to e) predict a protein fold pattern of the protein of interest having an unknown fold pattern by comparing the two or more structural or sequence features of the protein of interest having an unknown fold pattern to the correlation.

29. The system of claim 27 wherein the input of associated with the protein of interest having an unknown fold pattern comprises its amino acid sequence.

30. The system of claim 26 further comprising a database of the correlations.

31. A system comprising:
a computing device;
means for receiving an input associated with two or more structural or sequence features of a protein of interest having an unknown fold pattern; and
means for predicting one or more protein fold patterns of the protein of interest having an unknown fold pattern based on correlating a) two or more structural or sequence features of a plurality of proteins having a known protein fold pattern to b) the known protein fold pattern.

32. The system of claim 31 further comprising:
means for training a system to correlate a) the two or more structural or sequence features of a plurality of proteins having a known protein fold pattern to b) the known protein fold pattern.

33. The system of claim 31 further comprising means for storing the correlation of the two or more structural or sequence features of the plurality of proteins having a known protein fold pattern to the known protein fold pattern.

34. The system of claim 31, wherein the computing device comprises:
one or more of a desktop computer, a workstation computer, a computing system comprised of a cluster of processors, a networked computer, a tablet personal computer, a laptop computer, or a personal digital assistant.

35. The system of claim 31, wherein the computing device is operable to communicate with the database to access the correlations.
